(19) United States
(12) Patent Application Publication
(10) Pub. No.: US 2014/0380361 A1
(43) Pub. Date: Dec. 25, 2014

(54) PROCESS AND USER INTERFACE FOR DOWNLOADING MUSICAL CONTENT

(71) Applicant: THOMSON LICENSING, Issy de Moulineaux (FR)

(72) Inventor: Alaleh Towhidi BAGHINI, San Marcos, CA (US)

(21) Appl. No.: 13/921,289

(22) Filed: Jun. 19, 2013

(51) Int. Cl. H04N 21/431; H04N 21/858; H04N 21/435; H04N 21/4722

(52) U.S. Cl. CPC H04N 21/431; H04N 21/4722; H04N 21/8586; H04N 21/435
USPC 725/37

(57) ABSTRACT

A method for offering at least one piece of content available for downloading to a viewer of a viewed program commences by first extracting from the viewed program information indicative of at least one piece of content associated with the viewed program available for downloading. Thereafter, a link established to a source of the content available for downloading. Lastly, both a portion of viewed program and the established link undergo display to the viewer so the viewer can actuate the link and download the at least one piece of content.

### TECHNICAL FIELD

This invention relates to a method and apparatus for downloading content.

### BACKGROUND ART

Providers of television programs, such television stations as well as cable and satellite television providers often offer programs with musical content. Examples of such television programs include Smash, Glee, and The Voice, among others. A viewer watching a television program show containing musical content may want to acquire one or more songs played during the television program for listening again at a later time. Currently, a viewer who wants to acquire songs played during a television program typically must visit a website maintained by a musical content provider, such as the I-tunes website operated by Apple

Computer, to download the music performed during the television programs. Requiring the viewer to visit a web site to acquire the desired song(s) entails the use of a device separate from television set for this purpose. Thus, when a viewer makes use of a computer or smart phone to download the music he or she wants, the viewer's attention will shift from the viewed program. Even if the viewer can use the same device to both view the program and download the desired content, the viewer will typically need to exit the device mode allowing the user to view the program and enter a device mode allowing the user to download the desired song(s).

### BRIEF SUMMARY OF THE INVENTION

Briefly, in accordance with a preferred embodiment of the present principles, a method for offering at least one piece of content available for downloading to a viewer of a viewed program commences by first extracting from the viewed program information indicative of at least one piece of content associated with the viewed program available for downloading. Thereafter, a link established to a source of the content available for downloading. Lastly, both a portion of viewed program and the established link undergo display to the viewer so the viewer can actuate the link and download the at least one piece of content.

### BRIEF SUMMARY OF THE DRAWINGS

FIG. 1 depicts a block schematic diagram of a system for practicing the content downloading technique of the present principles;

FIG. 2 depicts a block schematic diagram of a program receiving device comprising part of the system of FIG. 1;

FIG. 3 depicts a screen-shot displayed in connection with content down-loading in accordance with the present principles.

### DETAILED DESCRIPTION

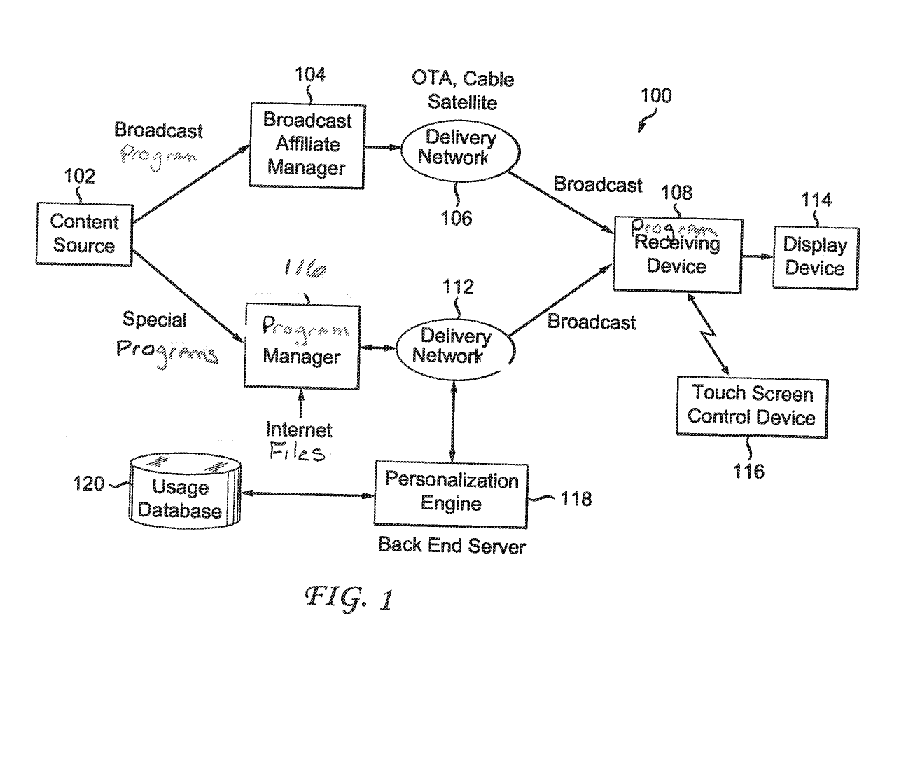

FIG. 1 depicts a block diagram of an embodiment of a system 100 for delivering one or more programs to viewer (not shown). The program(s) typically comprise audio-visual files, for example movies or television programs, that originate from a content source 102 which can deliver programs in at least two forms. For example, the content source 102 can deliver programs in the form of “broadcast” programs of the type formatted for terrestrial broadcast by a broadcast affiliate manager 104, typically a national television broadcast network operated by American Broadcasting Company (ABC), National Broadcasting Company (NBC), Columbia Broadcasting System (CBS), etc. The broadcast affiliate manager 104 can collect and store the program, and can schedule delivery the program over a delivery network 106, which can include a wired or wireless communications network or a combination of over-the-air (OTA), cable television and/or satellite communication networks.

The content source 102 can also deliver programs in a special form, such as premium or pay-per-view programs otherwise not provided to the broadcast affiliate manager 104. For example, such special programs can include first run movies offered to viewers in response to their request. The content source 102 provides such special programs to a program manager 110, which can comprise a service provider, such as an Internet website, affiliated with a program provider, broadcast service, or network delivery service. The program manager 110 can also incorporate Internet files for delivery with one or more special programs. In practice, the program manager 110 delivers special programs (and associated Internet files) over a separate delivery network 112, which can include a Wide-Area Network (WAN), Local-Area Network (LAN) and/or high-speed broadband communications network, including, but not limited to, the Internet. Note that the programs provided by the broadcast affiliate manager 104 could undergo delivery using all or part of delivery network 112 and programs from the program manager 110 could undergo delivery using all or part of delivery network 106. In addition, the delivery of programs could occur directly via the network 112 without the need for the program manager 110.

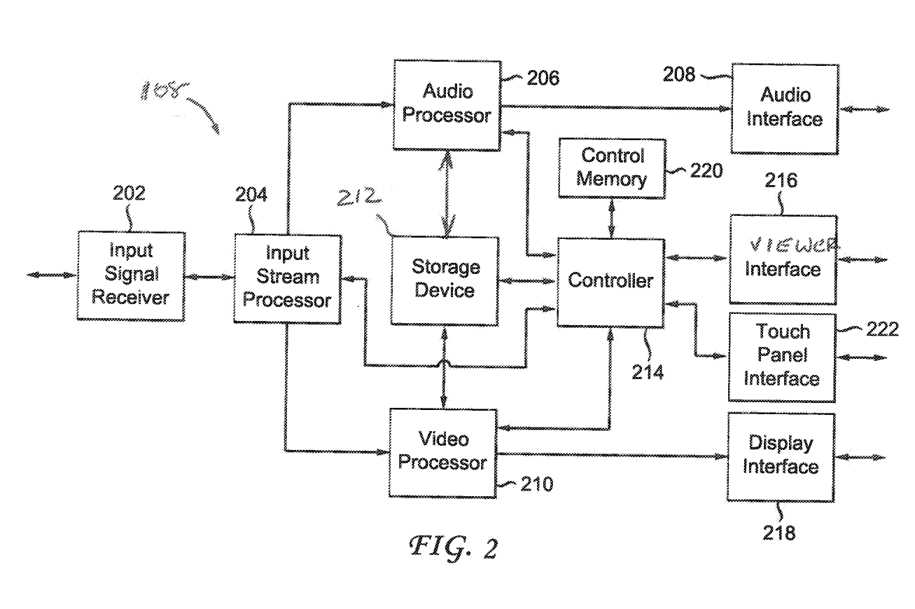

At a local premise, such as a home or the like, a viewer will make use of a program receiving device 108, described in greater detail with respect to FIG. 2, to receive programs via the networks 106 and 112 for processing and subsequent display on a display device 114, such as a television set or the like. The program receiving device 108 can take many forms, such as a set-top box, gateway, modem or the like, the functionality of which can be embodied in devices such as a digital video recorder, personal computer, television set, etc. and may be embodied as a set top box/digital video recorder (DVR), a gateway, a modem, etc. Further, the program receiving device 108 may act as entry point, or gateway, for a home network system that includes additional devices configured as either client or peer devices in the home network (not shown).

The program receiving device 108 processes the programs received via the networks 106 and 112 and separates the programs based on viewer preferences and commands The program receiving device 108 can include a storage device, such as a hard drive or optical disk drive (not shown), for program recording and playback. The program receiving device 108 can interface to a second screen in the form of a touch screen control device 116 to allow the viewer to control both the program receiving device 108 and the display device 114. The touch screen control device 116 also has the capability displaying video content, including, but not limited to, viewer data entries as well as a portion of the video content delivered to the display device 114. In accordance with an aspect of the present principles, the touch screen control device 116 also has the capability of displaying to the viewer information indicative of downloadable content associated with the program received by the program receiving device 108 and displayed by the display device 114. Such content can include musical compositions for example comprising part of the program undergoing display. As described in greater detail below, the viewer can use the touch screen control device 116 to select the content for downloading, while still watching the portion of the program undergoing display on that device.

In practice, the touch screen control device 116 can take a variety of forms. For example, the touch screen control device 116 could take the form of a tablet device, such as the Apple I-Pad, or Samsung Galaxy Note tablet. Alternatively, the touch screen control device 116 could take the form of a smart phone or lap-top computer or any other similar device that can send and receive data as well as provide a display of such data. The touch screen control device 116 typically interfaces to the program receiving device 108 which can include one or more of any well-known wireless transmission mechanisms including, but not limited to infra-red (IR) or frequency (RF) communications and can make use standard protocols such as infra-red data association (IRDA) standard, Wi-Fi, or Bluetooth wireless protocols, as example.

The system 100 can include a back end server 118 and a usage database 120. The back end server 118 includes a personalization engine that analyzes the usage habits of viewers sand makes recommendations based on those habits. The usage database 120 stores viewer data indicative of habits and also stores viewer profiles generated by the server 118.

FIG. 2 depicts a block schematic diagram of an exemplary embodiment of the receiving device 108 of FIG. 1. As illustrated in FIG. 2, the receiving device 108 includes an input signal receiver 202 that receives programs via the networks 106 and 112 shown in FIG. 1. The input signal receiver 202 can comprise one of several known receiver circuits used for receiving, demodulating and decoding received program(s). An input stream processor 204 receives the decoded program(s) and performs the final signal selection and processing, including separation of video from audio in the decoded program(s). The input stream processor 204 supplies the audio to an audio processor 206, which generates an audio signal for receipt by an audio interface 208 that provides the signal to the display device 114 of FIG.

1, or other device (not shown) for audio reproduction. Typically, the audio interface 208 generates an analog audio signal. Alternatively, the audio interface 208 could generate a digital signal. Additionally, the audio processor 206 supplies audio signals to a storage device 212 for storage. The input stream processor 204 also provides a video output signal to a video processor 210, which undertakes signal conversion to provide a video signal of the appropriate format for storage in the storage device 212 and for display. A display interface 218 interfaces the video processor 210 to the display device 114 of FIG. 1.

The storage device 212, which stores program audio and video, allows later retrieval and playback of the program under the control of a controller 214 in accordance with commands received by the viewer through a viewer interface 216 and/or a touch panel interface 222 which provides an interface to a touch panel (not shown) separate from, or integrated with the display device 114 of FIG. 1. The viewer interface 216 provides the mechanism by which the touch screen control device 116 of FIG. 1 interfaces to the controller 214.

The storage device 212 can comprise be a hard disk drive, one or more large capacity integrated electronic memories, such as static RAM (SRAM), or dynamic RAM (DRAM), or an interchangeable optical disk storage system such as a compact disk (CD) drive or digital video disk (DVD) drive.

The controller 214 controls the operation of program receiving device 108 and to that end, the controller has bus interconnection to the input stream processor 202, the audio processor 206, the video processor 210, the storage device 212, the view user interface 216 and the touch panel interface 222. The controller 214 manages the conversion process for converting the input stream signal into a signal for storage on the storage device 212 or for display. The controller 214 also manages the retrieval and playback of stored programs.

The controller 214 also has a bus interconnection to a control memory 220 (e.g., a volatile or non-volatile memory, including RAM, SRAM, DRAM, ROM, programmable ROM (PROM), flash memory, electronically programmable ROM (EPROM) , electronically erasable programmable ROM (EEPROM), etc.) for storing information and instruction code for controller 214. The control memory 220 can also store a database of elements, such as graphic elements for generating a graphical user interface for display to the viewer.

In accordance with the present principles, the controller 214 has the capability of extracting the identification of downloadable content in the program(s) received at the input signal receiver 202. Upon identification of such content, the controller 214 will establish and display a link for display to such content, either on the display device 114 or on the touch screen control device of 116, both of FIG. 1, for actuation by a viewer to select such content. To enable identification of such downloadable content, the program(s) received at the input signal receiver 202 originating from the content source 202 of FIG. 1 typically include metadata that describes such content and the sources where a viewer can download such content. In connection with processing of the incoming programs received at the input signal receiver 202, the input stream processor 204 will extract such metadata for transmission to the controller 214 which will then establish a link to such content source.

In the event that an incoming program includes metadata that identifies associated content available for downloading, the controller 214, in response to such metadata, will launch an application stored in its control memory 220 to process the metadata to recover any display links to such content. Such links can be hyperlinks, URLs or other well-known mechanisms which a viewer can actuate to obtain content, e.g., musical compositions, corresponding to such link. Based on the extracted metadata, the controller 214 could also launch a search to other sources (not shown) for downloadable content related to, but not specifically identified by the received program.

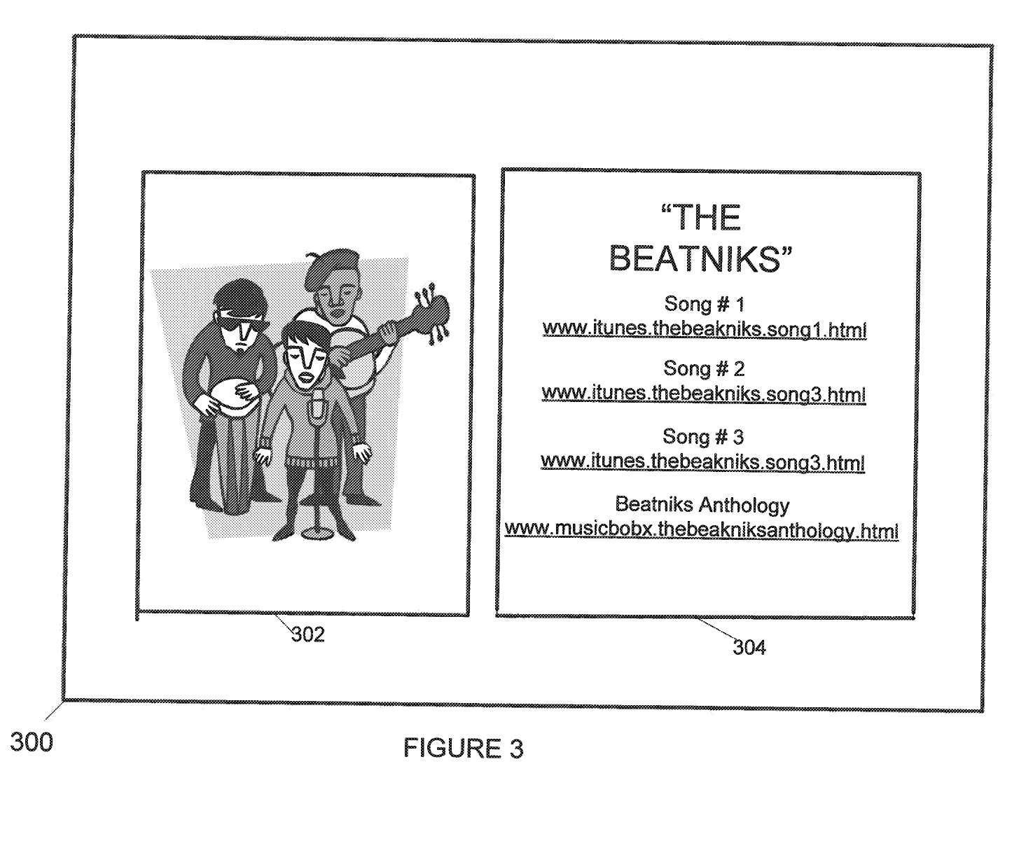

FIG. 3 which depicts a screen display 300, displayed either by the display device 114 or the touch screen control device 116, both of FIG. 2 which further illustrates the content downloading technique of the present principles. The screen 300 of FIG. 3 includes first and second screen portions 302 and 304. The first screen portion 302 provides a display of the received program, in this case a concert by the musical group “The Beatniks.” The second screen portion 304 includes a banner display that identification of the performing artist (i.e., “The Beatniks”) and includes a display of links to the content (the songs) identified in the program metadata extracted by the stream processor 204 of FIG. 1 as available for downloading. As example, assume that the extracted metadata identifies the following musical compositions “Song #1,” “Song #2,” and “Song #3.,” as associated with the program and available for downloading. Thus, the screen portion 304 will include a listing of each musical composition, as well as a link (e.g., links to that song so that the viewer can watch the program and actuate the link(s) to download musical composition(s) of interest.

As discussed above, the controller 214 can launch an application to search for content related to, but not specifically identified in metadata of the received program. For example, from knowledge of the name of the performing artist, the controller 214 can launch a search for other musical compositions for that artist. In the illustrated embodiment, knowing that the musical artist is “The Beatniks,” the controller 214 has identified the musical composition “Beakniks Anthology” as available for downloading and has included a link to that composition in the display appearing in the second screen portion 304 of FIG. 3.

As noted above, the screen 300 can undergo display on either the display device 114 or the touch screen control device 116. In the event that the touch screen control device displays the screen 300 of FIG. 3, the display device 114 can provide a full screen display of the program for viewing (not shown).

The foregoing describes a technique for facilitating downloading of content associated with a program during viewing.

1. A method for offering content available for downloading to a viewer of a viewed program, comprising the steps of:
extracting, from the program, information indicative of at least one first piece of content associated with the program;
establishing a first link to a source of the at least one first piece content in accordance with the extracted information;
searching for at least one second piece of content related to the at least one first piece of content;
establishing a second link to a source of the at least one second piece content;
displaying both a portion of the program and the first and second links to the viewer so the viewer can actuate at least one of the first and second links and download.

2. The method according to claim 1 wherein the program and the first and second links undergo display on a first display device.

3. The method according to claim 1 wherein the viewed program and the first and second links undergo display on a second display device while a first display device provides a full screen display of the program.

4. The method according to claim 1 wherein the content includes a musical composition.

5. The method according to claim 1 wherein the extracted information includes metadata.

6. (canceled)

7. Apparatus for enabling downloading of content available to a viewer of a viewed program, comprising,
a stream processor for receiving a program for viewing and for (a) extracting, from the program, information indicative of at least one first piece of content associated with the program, and (b) searching for at least one second piece of content related the at least one first piece of content;
a controller for (a) establishing a first link to a source of the at least one first piece of content, (b) establishing a second link to a source of the at least one second piece of content related to the first piece of content, and (c) displaying both a portion of the program and the first and second links to the viewer so the viewer can actuate one of the first and second links and download content.

8. The apparatus of claim 7 further including a first display device for displaying the program and the first and second links.

9. The apparatus of claim 7 further including a first display device for displaying the program and a second display device for displaying the program and the first and second links.

10. The apparatus according to claim 7 wherein the content includes a musical composition.

11. The apparatus according to claim 7 wherein the extracted information includes metadata.

12. (canceled)
